(19) United States
(12) Patent Application Publication
(10) Pub. No.: US 2020/0265481 A1
(43) Pub. Date: Aug. 20, 2020

(54) DONOR AND RECIPIENT AUTHENTIC AUTHORIZATION

(71) Applicant: Bank of America Corporation, Charlotte, NC (US)

(72) Inventor: Manu Kurian, Dallas, TX (US)

(21) Appl. No.: 16/276,694

(22) Filed: Feb. 15, 2019

(51) Int. Cl. G06Q 30/02; G06Q 20/10

(52) U.S. Cl. CPC G06Q 30/0279; G06Q 20/10

(57) ABSTRACT

A method for facilitating donor-controlled distribution of charitable donations is provided. The method may include receiving data from a donor corresponding to a donation, creating a plurality of sub-assets where each sub-asset relating to a portion of the value of funds. The method may further include receiving an identification of a plurality of donor-selected events, associating each of the sub-assets with each of the plurality of donor-selected events and adding to a blockchain a first block recording metadata for each of the sub-assets. The method may further include receiving a request for charity (“RFC”) associated with an event, scanning the blockchain for a donor-selected event correlating to the RFC event, extracting from the blockchain the metadata from a number of sub-assets correlating to the RFC event, completing a transaction of the requested donation amount to the charitable organization and creating a second block recording the completed transaction.

### FIELD OF TECHNOLOGY

Aspects of the invention relate to donor-controlled distribution of charitable donations.

### BACKGROUND OF THE DISCLOSURE

Charitable systems use online portals to enable donors to donate charity to organizations. This eliminates the need for telephone solicitation and direct mail. Transmitting much needed funds via online portals enables desperate charity organizations to receive donations almost instantaneously. Because of the ease of using online donation portals to contribute to charity, donors are motivated and encouraged to donate more frequently.

Many online charitable trust systems offer the option to donate to numerous types of organizations. These organizations may include profile data on the charitable trust system and may be linked to the system. The donor may be able to direct his contribution to one or more of the organizations linked to the system however the donor may not be validated as to the actual outcome of the donation.

It would be desirable to have a charitable trust system that may be enabled to divide the donation amount received from a donor into single and/or multiple units and enable the donor to aggregate the units into different size batches to be directed to specific recipients according to the donor's wishes.

It would be further desirable to have systems and methods to enable the donor to view and audit the outcome of each single unit of the donor's donation and the recipient for each single unit of the donor's donation.

### SUMMARY OF THE DISCLOSURE

Systems and methods for method for facilitating donor-controlled distribution of charitable donations are provided. The method may include receiving data from a donor. A donor, for the purpose of the invention, may be an individual or organization wanting to make a contribution to a charitable organization. The data may be related to a donation of a value of funds received from the donor to a charitable trust system. The data may include a donor name and a donation amount equal to the value of funds donated. The data may also include payment information.

The method may further include creating a plurality of sub-assets. Each sub-asset may relate to a portion of the value of funds. In certain embodiments, the plurality of sub-assets may be equal to the value of funds donated. The method may also include assigning to each of the plurality of sub-assets, a sub-asset number.

The method may further include receiving an identification of a plurality of events selected by the donor. The plurality of donor-selected events may be prospective recipients of the donation of the value of funds. The donor-selected events may be associated with a charity organization. In response to the receiving the plurality of donor-selected events, the method may further include associating each of the sub-assets with each of the plurality of donor-selected events.

The method may further include adding to a blockchain a first block. The first block may be for recording metadata associated with each of the sub-assets. The metadata may include, for each of the sub-assets, a name of the donor, the sub-asset number, the donor-selected events associated with each sub-asset and a numeric value of the related portion of funds.

The method may further include receiving a request for charity (“RFC”). The RFC may be received from a charitable organization. The RFC may include a requested donation amount. The RFC may be associated with an RFC event. The event may be identified with or as a natural disaster. The event may be associated with poverty. The event may be illness/disease related. The event may be associated with military needs. The event may be associated with educational opportunities. The event may be associated with other known and/or not well-known charitable needs. The request may be a request for a donation. The request may include a description of the RFC event, a description of the charitable organization and a requested donation amount.

In response to receiving the request, the method may further include scanning the blockchain. The scanning of the blockchain may be configured to search for one or more sub-assets that may be associated with a donor-selected event correlating to the RFC event from the charitable organization.

The method may further include extracting metadata from a number of sub-assets correlating to the RFC event. A total portion of the value of funds associated with each of the number of sub-assets may add up to the requested donation amount. The number of sub-assets may be associated with the event. The number of sub-assets may include one or more of the plurality of sub-assets associated with the donor.

The method may further include completing a transaction of the requested donation amount to the charitable organization. The completing of the transaction may include transferring a value of funds from the charitable trust system to the charitable organization. The value of funds may be equal to a sum total value of each of the portion of the value of funds associated with the extracted sub-assets.

Following the transferring of the value of the funds to the charitable organization, the method may further include creating a second block. The second block may be for recording the completed transaction. The second block may record a listing of each of the sub-assets transferred to the charitable organization. The second block may further record the sub-asset number associated with each of the transferred sub-assets. The second block may also record the portion of the value of funds associated with each of the transferred sub-assets. The second block may further record, for each of the transferred sub-assets, the charitable organization associated with the RFC where the value of funds has been transferred. The second block may be linked to the first block. The metadata may be directly transferred from the first block to the second block thereby deepening inter-block relationship on the blockchain.

The method may further include transmitting a communication to the donor. The communication may include a confirmation of the transaction. The confirmation may also include the RFC event and the charitable organization where the value of funds has been transferred. The confirmation may further include the total value of funds transferred to the charitable organization.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows an illustrative system in accordance with principles of the invention.

FIG. 2 shows an illustrative flow chart in accordance with principles of the invention.

FIG. 3 shows an illustrative diagram in accordance with principles of the invention.

FIG. 4 shows another illustrative flow chart in accordance with principles of the invention.

FIG. 5 shows another illustrative diagram in accordance with principles of the invention.

FIG. 6 shows yet another illustrative flow chart in accordance with principles of the invention.

FIG. 7 shows an illustrative graphical user interface (“GUI”) in accordance with principles of the invention.

FIG. 8 shows yet another illustrative diagram in accordance with principles of the invention.

FIG. 9 shows still another illustrative diagram in accordance with principles of the invention.

FIG. 10 shows still another illustrative diagram in accordance with principles of the invention.

FIG. 11 shows still another illustrative diagram in accordance with principles of the invention.

FIG. 12 shows still another illustrative diagram in accordance with principles of the invention.

FIG. 13 shows another illustrative system in accordance with principles of the invention.

FIG. 14 shows another illustrative system in accordance with principles of the invention.

### DETAILED DESCRIPTION OF THE DISCLOSURE

Aspects of the disclosure relate to a charitable trust system for facilitating donor-controlled distribution of charitable donations. The charitable trust system may be an online system linked with a plurality of charitable organizations.

The charitable trust system may include a database of a large number of charitable organizations that may be enrolled in the system. The charitable trust system may be dynamic and may be configured to receive a constant flow of new charitable organizations requesting to join the system and/or to delete charitable organizations that are part of the system, on an as needed basis. The charitable trust system may also be in synchronization with real-time news, weather channels and social media networks.

The charitable trust system may be configured to receive donations from donors and record where, and for what purpose or intent, the donation has been donated. The recording, in this embodiment, may be on a blockchain. Implementing blockchains for use as a recording ledger for donor contributions within a charitable trust system adds significant confidence and security to the donor. It gives the donor reassurance that his contribution will reach the desired recipient. Because blockchains are an immutable and transparent ledger that is fully accessible to view, recording donations from donors and further recording where every dollar has in certainty been donated, gives donors the ability to fully audit, monitor and verify the direction and execution of their charitable donations.

The system may include a processor. The processor may be configured to receive data from a donor. The donor may be in electronic communication with the charitable trust system via a mobile device. The communication may be via the internet. The data may be related to a donation of a value of funds being donated to the charitable trust system.

The data received from the donor may include a donor-name, a donation amount equal to the value of funds donated and payment information. The payment information may include information associated with a credit card payment. The payment information may include bank routing data for donating via a wire-transfer. The payment information may include, but is not limited to, other methods of payment.

The processor may be further configured to create a plurality of sub-assets. Each of the sub-assets may correspond to a portion of the value of funds. The processor may also be configured to assign, to each of the plurality of sub-assets, a sub-asset number. The processor may be further configured to receive identification, from the donor, of a plurality of types of events. Each of the types of events may be associated with each of the sub-assets. In certain embodiments, the processor may also be configured to receive a pre-determined amount to be allocated to each of the plurality of types of events.

Types of events, for the purpose of this disclosure may be a more detailed selection of a type of event included within a broader scope of events. Natural disasters, illnesses, education and other events may be a broad description of an event. Types of events may be a more specific and direct event. For example, a specific natural disaster may be associated with a flood occurring now, or that has occurred in the recent or distant past within a specific location. The specific natural disaster may be associated with a hurricane in a specific location.

The processor may be further configured to, in certain embodiments, also receive, along with the plurality of events, a pre-defined amount of funds to be designated for each of the plurality of events, from the total value of funds. When a pre-defined amount of funds is received, the processor may then be configured to associate each event with an amount of sub-assets.

The numeric value of funds recorded for the sub-assets associated with each event may equal to a total value of the pre-defined amount designated. For example, a donor may wish to donate a total of $1000.00. From the total, the donor may designate a first portion equal to $350 towards natural disaster events. The donor may designate a second portion equal to $400 towards poverty events. The donor may designate a third portion equal to $250 towards illness or illness events. The sub-assets recording natural disaster events may sum up to a numeric value equal to 350. The sub-assets recording poverty events may sum up to a total numeric value equal to 400. The sub-assets recording illnesses may sum up to a numeric value equal to 250. The total sum of the portion of funds allocated to each of the amount of sub-assets may add up to the pre-defined amount of $1000.00 received from the donor.

In certain embodiments, the plurality of sub-assets may be a number of sub-assets equal to the value of funds received from the donor. For example, when a donor submits a donation of $100, the processor may create 100 sub-assets. Each sub-asset may then be assigned a unique sub-asset number. Each sub-asset may correspond to a portion of the donation of $100. According to this embodiment, each sub-asset may correspond to the value of $1.00.

By creating sub-assets equal to the value of funds, this may enable the donor to aggregate any number of sub-assets, in real-time, and allocate the value of the funds associated with the aggregated sub-assets, to any one or more charitable organizations. This may include enabling the donor to receive a communication. The communication may be a real-time communication from the charitable trust system. The communication may be transmitted by the system when events occur that may necessitate, or indicate a need for, donations. The system may also be configured to, without donor-input, allocate the number of sub-assets equal to the donation amount included in the request.

In response to the receipt of the data and prior to recording the data, the system may be configured to process the payment based on the payment information included in the data. The processor may be configured to initiate a transaction for a payment based on the payment information. The system may be linked to a payment processor for processing the payment. The payment processor may be enabled to securely process the donor's financial information and transfer it to the non-profit charitable organization. Following the processing, the system may be configured to retain the processed payment in a merchant account of the charitable trust system. The payments may be held in the merchant account until an incoming donation request may be received that may correspond to the event associated with the processed donation thereby transferring the funds to the charitable organization. There may be a routing number linked to the merchant account. Routing data associated with the merchant account may be recorded with each sub-asset.

The system may further include a distributed network. The distributed network may include a plurality of decentralized nodes. The processor may be a centralized or decentralized processor that may be in electronic communication with at least one of the decentralized nodes. Each of the decentralized nodes may reside at different locations. Each location may be linked to the charitable trust system.

One or more of the decentralized nodes may be configured to add to a blockchain a first block. The first block may record each of the sub-assets and the event associated with each of the sub-assets. In certain embodiments, the first block may further record the pre-determined amount from the value of funds to be allocated to each of the associated events. It should be appreciated that the first block added to the blockchain may not be the first block recorded on the blockchain. The blockchain may include a plurality of blocks relating to donations received in the system at different instances.

Blocks added to the blockchain may be hashed using methods known to those skilled in the art. The mining of new blocks may be executed according to methods known to those skilled in the art.

The system may be configured to receive a request for charity (“RFC”.) The RFC may be associated with an RFC event. The RFC event may be associated with charitable organizations already linked to the system. These linked charitable organizations may have ongoing daily, weekly and/or monthly requests.

In certain circumstances, the request may be associated with a real-time occurring event. When the request is received from a charitable organization for a donation, the request may include a description of the charitable organization and a requested donation amount. Because the system is in synchronization with news channels and social media networks, when a real-time event occurs that is in need of immediate donations, the system may be configured to communicate with one or more donors included in the system and the donors may be enabled to select and assign any amount of sub-assets associated with a received donation to the real-time event. Communication between the one or more donors and the system may be via one or more of email, text messaging and alerts on an application (“app”) associated with the charitable trust system that may be downloaded on the donor's mobile device.

When the request is received, the processor may be configured to scan the blockchain for one or more donor-selected events correlating to the RFC event. The processor may be configured to retrieve metadata incorporated in the request associated with the RFC event and scan the blockchain for comparative metadata associated with the donor-selected events recorded within each of the sub-assets.

The scanning of the blockchain may further include comparing data associated with the description of the RFC event and charitable organization to data associated with the donor-selected event. The method may further include, in response to the comparing, determining a word match and/or a partial word match between the data from the descriptions and the data associated with the donor-selected event. This may enable correlating donor-selected events to the RFC event.

In certain embodiments, the processor may be configured to scan the blockchain from an oldest-date stamped block to a latest-date stamped block. This may enable creating a hierarchy enabling an earlier donor to donate prior to a subsequent donor.

Following the scanning of the blockchain, the processor may be further configured to extract from the blockchain a number of sub-assets that may be determined to be associated with the RFC event. The numeric value associated with the number of sub-assets may be equal to the total requested donation amount.

The processor may be further configured to complete a transaction. The transaction may include a transfer of funds of the requested donation amount from the charitable trust system to the charitable organization. The value of funds may be a total value of the portion of the value of funds associated with each of the sub-assets.

When the transaction is completed the distributed network may be further configured to create a second block. The second block may record the completed transaction. The second block may record a listing of each of the sub-assets transferred to the charitable organization. The second block may further record the sub-asset number associated with each of the transferred sub-assets. The second block may also record the portion of the value of funds associated with each of the transferred sub-assets. The second block may further record, for each of the transferred sub-assets, the charitable organization associated with the RFC where the value of funds has been transferred.

The charitable organization that received the funds may transfer the funds to a need associated with the RFC event. The system may be configured to record the actual end system that may have received the funds. The funds may be transferred to pay off an outstanding balance. The funds may be transferred to purchase clothing/items for an individual and/or a community that may have experienced a natural disaster. The funds may be transferred to assist a student in furthering his education. In accordance with embodiments of the invention, wherever the donated funds have been transferred, the actual recipient, and/or a confirmation of a receipt thereat, may be recorded on the second block. For example, if the funds were transferred to a utility company to pay off an outstanding balance, the name of the utility company may also be recorded on the second block. In certain embodiments an actual document confirming receipt may be recorded therewith.

The second block may be subsequent to the first block. The second block may not immediately follow the first block. The second block may be linked to the first block. The metadata may be directly transferred from the first block to the second block thereby deepening inter-block relationship on the blockchain.

Using a blockchain for recording donations received in a charitable trust system enables the donors the ability to monitor and audit where every dollar of their donations are being spent. By creating sub-assets equal to the value of the funds donated, this enables the donors to allocate and direct each sub-asset and its associated value to any desired charitable organization. Since the blockchain is configured to record further each completed transaction, the donor may be able to view and confirm that each donated dollar was designated to an organization that the donor requested and/or preferred.

The processor may be further configured to transmit to the donor, confirmation of the transaction. The confirmation may also include the description of the donation received from the charitable organization. The confirmation may further include a total value of funds transferred to the charitable organization. The confirmation may be transmitted via one or more of email, text-messaging and/or the charitable trust system app.

In certain embodiments, the processor may be configured to transmit further with the confirmation, to the donor, an image or video of an actualization of actions taken pursuant to the donation. For example, donor ‘A’ may have identified that his donation be directed to i.e.—outerwear' for children located in third world countries. When an RFC is received within the system for donations towards ‘clothing’ for children located in a third world country, the system may scan the blockchain to identify an event match between the RFC and the donor-selected events. The system may then be further configured to transfer donor ‘A’s donation to the charitable organization associated with the RFC. In this example, the system may e-mail a picture of the children that benefitted from donor ‘A’s donation, i.e.—wearing winter coats. In another example, the image may include a snapshot of a confirmation document confirming a payment for an outstanding utility bill.

In certain embodiments, the processor may scan the metadata in the blockchain for donor-selected events that may correspond to the RFC event, and may determine that there are no donor-selected events correlating to the RFC event. In this event, the processor may be configured to retrieve a donor-selected event associated with one or more sub-assets that correlates with an event outside the RFC event.

The processor may further be configured to transmit a communication to the donor associated with the one or more sub-assets for a request of an exception for redirection of the sub-asset to the RFC event. The communication may be transmitted via email, text-messaging, an alert on the charitable trust system app and/or any other form of communication.

In response to the receipt of the communication, the donor may desire to redirect the donation to the RFC event. In many instances, the RFC may be associated with a real-time event i.e—flood, hurricane, fire, and the donor may be enthusiastic to have an opportunity to donate to the event despite the fact that the donor's original intent may have been to donate to a different cause.

The processor may be configured to receive a confirmation to redirect, the donor-selected types of events of the one or more sub-assets, to the requested charitable organization. In response to the receipt of confirmation, the processor may be further configured to extract from the blockchain the one or more sub-assets that received the confirmation for the exception request. The processor may also be configured to complete a transaction of the requested donation amount to the charitable organization associated with the RFC. The processor may further be configured to record on the second block, a list of each of the sub-assets extracted from the blockchain and confirmation data confirming the redirection of the sub-assets to the requested charitable organization. The recording of the second block enables the donor to review the donations and the actual recipients of the donor's donation.

According to certain embodiments, one or more charitable organizations that may be associated with the charitable trust system, may be linked to each other. For example in one embodiment, one charity may assist a second charity to draw resources. In such an embodiment, a first charity may vouch for a second charity. For example, charity A may vouch for charity B and may want to assist in raising funds for charity B. When a donor submits a donation, the donor may identify selected events, types of events and/or one or more specific charity organizations that he may approve to be recipients of the funds. When the donor identifies specific charity organizations as potential recipients of the funds, the system may be configured to further request the donor to either opt-in or opt-out for a pre-approval, if necessary, of a transfer of the donated funds to any one or more charities that may be linked to the identified selected charity organizations. It should be appreciated that an approval of a transfer of funds to a second charity linked to the selected charity may be, in certain embodiments, offered as a temporary inline approval. When the need may arise, the system may be configured to transmit a communication request to the donor for an approval of a transfer of the funds to the second charity.

In another embodiment, a charitable trust system may be configured to receive a plurality of data. The charitable trust system may also facilitate donor-controlled distribution of charitable donations. The system may include a processor. The processor may be configured to receive the plurality of data. Each of the plurality of data may relate to a donation of a value of funds to the charitable trust system. Each of the plurality of data may be associated with a distinct donor.

The processor may be configured to create an asset for each of the plurality of data. Each asset may correspond to the value of funds. Each asset may include a plurality of sub-assets. Each of the plurality of sub-assets may correspond to a portion of the value of funds associated with the asset.

The processor may further be configured to assign, to each asset, an asset number. The processor may further assign, to each of the plurality of sub-assets, a sub-asset number. The processor may be further configured to receive for each asset, from each donor, an identification of a plurality of donor-selected events. The plurality of donor-selected events may be associated with a charity organization.

For each asset, the system may be configured to associate to each of the plurality of sub-assets comprised within the asset, the plurality of donor-selected events. The processor may be in electronic communication with at least one of a plurality of decentralized nodes within a distributed network. The distributed network may be configured to add to a blockchain a plurality of blocks. The plurality of blocks may record metadata for each of the plurality of assets. Each block may be configured to record asset metadata for each asset. The asset metadata may include a name of the donor, the asset number, the plurality of sub-asset numbers associated with the asset number and a numeric value of the value of donated funds. Each block may record metadata for one asset. Each block may record metadata from a number of assets on a single block. Each block may be configured to record sub-asset metadata for each of the plurality of sub-assets. The sub-asset metadata may include the sub-asset number, the donor-selected events and a numeric value of the related portion of funds.

When a request is received for a request for charity (“RFC”) from a charitable organization, the RFC being associated with an RFC event, the RFC including a requested donation amount, the processor may be configured to scan the blockchain for one or more sub-assets associated with a donor-selected event correlating to the RFC event. The processor may extract from the blockchain, sub-asset metadata from a number of sub-assets associated with the RFC event, wherein a total of the portion of the value of funds associated with each of the number of sub-assets add up to the requested donation amount.

The system may be further configured to complete a transaction of the requested donation amount to the charitable organization. The completing may include a transfer of funds of the requested donation amount from the charitable trust system to the charitable organization, the value of funds being a total value of the portion of the value of funds associated with each of the extracted sub-assets.

The distributed network may be further configured to create an additional block. The additional block may be for recording the completed transaction listing each of the extracted sub-assets, the total value associated with the extracted sub-assets and the charitable organization associated with the RFC where the value of funds has been transferred. The system may transmit a communication to the donor. The communication may include a confirmation of the transaction, the value of funds transferred to the charitable organization and the charitable organization associated with the RFC where the value of funds has been transferred.

Illustrative method steps may be combined. For example, an illustrative method may include steps shown in connection with another illustrative method or another method described herein.

Apparatus may omit features shown and/or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

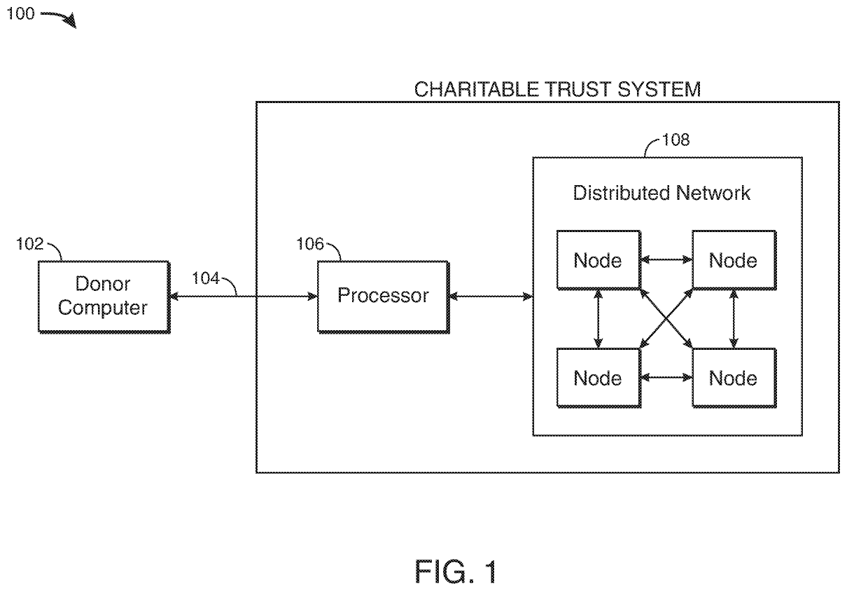

FIG. 1 shows an illustrative charitable trust system 100. Charitable trust system 100 may be a charity system including a processor 106 and a distributed network 110. The distributed network 104 may include a plurality of nodes within the distributed network. The distributed network may be configured to create and record blocks on a blockchain. The processor may be in electronic communication with at least one of the plurality of nodes via communication network 108. A user of the system may communicate with system 100. The user may access system 100 via computer 102. Communications network 104 may include a local area network and a wide area network such as the internet. Computer 102 may access system 100 via communications network 104.

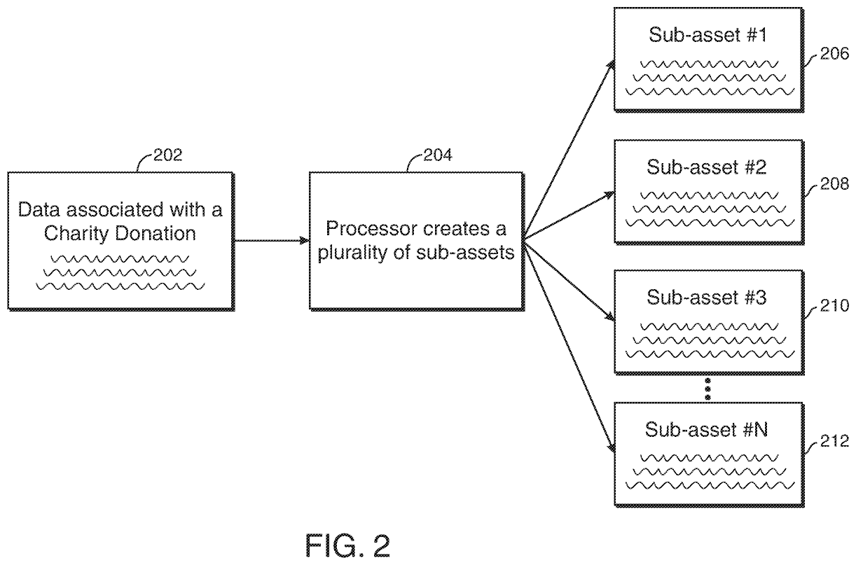

FIG. 2 shows an illustrative flow diagram of a receipt of a charitable donation within a charitable trust system. The diagram shows a first part in the process of processing the charitable donation. At step 202, data associated with a charity donation from a donor is transmitted to the processor. At step 204, the processor may be configured to receive the data and create a plurality of sub-assets where each of the sub-assets may relate to a portion of the charity donation. The plurality of sub-assets created may be shown at 206, 208, 210 and 212.

The system may run an algorithm to create the plurality of sub-assets. Each of the plurality of sub-assets may be associated with a portion of a value of the donation.

In some embodiments, each sub-asset may be associated with a one dollar value. In other embodiments, each sub-asset may be associated with a ten dollar value, a twenty dollar value, a fifty dollar value, or any other suitable dollar value.

In some embodiments, each sub-asset may represent a fraction of a value of the donation. For example, each sub-asset point may represent a tenth of a value of the donation, half of a value of the donation, a twentieth of a value of the donation, or any other suitable fraction value.

A dollar value associated with each sub-asset may be user-selected, pre-determined, or determined using an algorithm based at least in part on a dollar value of the donation. The algorithm may identify a dollar value of the donation, determine if the dollar value is greater than or equal to one or more thresholds, and, based on the thresholds, generate sub-assets, each sub-asset being associated with a value.

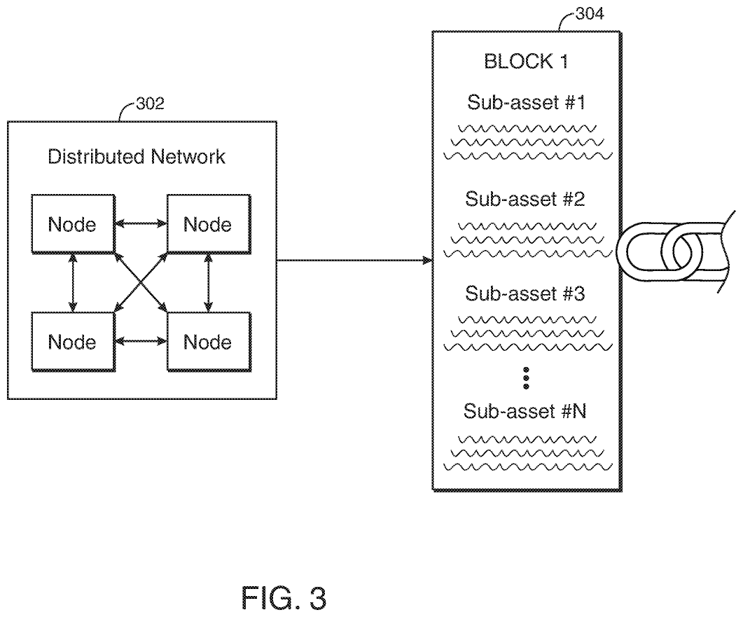

FIG. 3 shows an illustrative diagram of a second part in the process of processing the charitable donation within the charitable trust system. The charitable trust system may include a distributed network 302. The distributed network may include a plurality of nodes. Each of the nodes may include a processor that may create and record the blocks in a blockchain. The nodes may be linked and may all record the same data on each of the blocks in the blockchain. The plurality of sub-assets created, as shown at FIG. 1, may now be recorded on block 304. Block 304 may record each sub-asset and the data associated with each sub-asset.

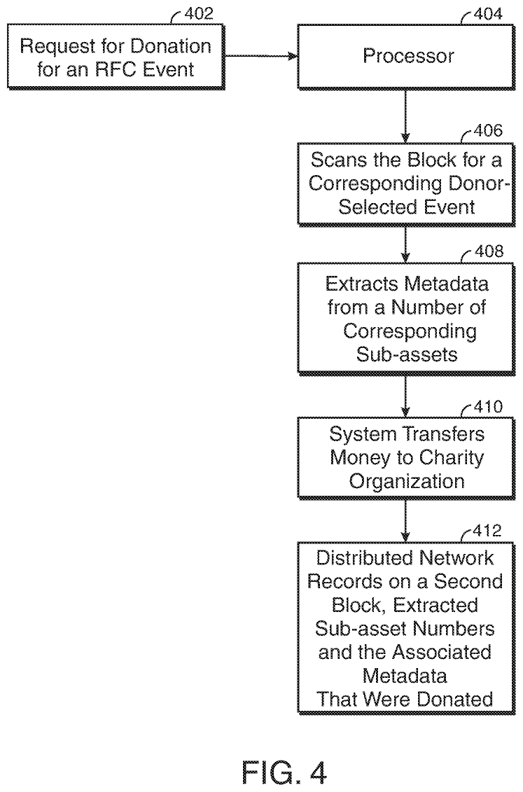

FIG. 4 shows an illustrative flow diagram of a third part in the process of processing the charitable donation within the charitable trust system. At step 402, a request for a donation for an RFC event associated with a charitable organization may be received at the processor 404. The Processor 404 may scan the block for a corresponding donor-selected event, as shown at step 406. Following the scanning, the processor may extract metadata from a number of corresponding sub-assets determined to correlate to the request for the donation, as shown at step 408. The metadata extracted may include for each sub-asset, a donor name, a value of the portion of the donated value of funds from the donor. The metadata may further include the events to wish the donor may wish to direct the donation.

The number of sub-assets where metadata may be extracted from may include a total value of funds equal to the requested donation amount. At step 410, the value of the requested donation amount may be transferred to the charity organization that sent the request. At step 412, the distributed network 302 may further record, on a second block, the extracted sub-asset numbers, the event that received the donation and the total value donated.

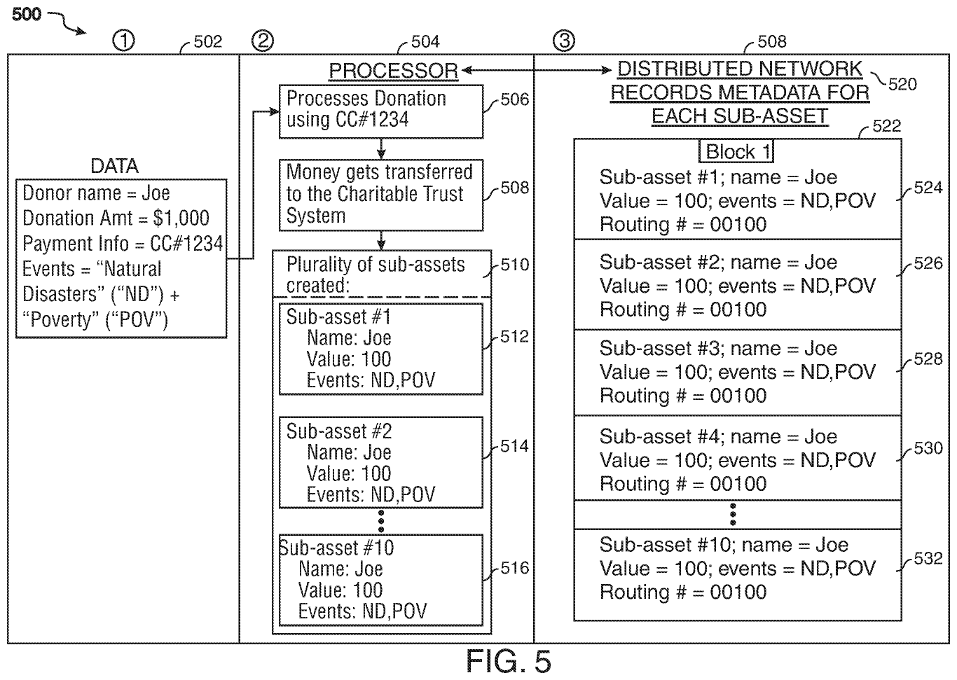

FIG. 5 shows an exemplary diagram of a process of a donation received within a charitable trust system 500. At column 1, step 502, a donation may be received at the charitable trust system 500. The donation may be received as a data packet. The data packet may identify, in this exemplary diagram, a donor name. The donor name may be “Joe.” The donation amount received from Joe may be a value of $1000.00. The payment information included in the data packet may be a credit card number. The payment information may as an alternative, may be a bank routing number and may be in a form of a wire transfer. In this example, Joe submitted a credit card number “1234.” The data packet may also identify donor-selected events. The events to which Joe wishes his donation to be directed are natural disaster charity types of events and poverty types of events. At column 2, step 504, the processor is configured to receive and process the data packet. At step 506, within column 2, system 500 may process the donation using the donor's credit card number 1234. The credit card may be processed via a payment processing system associated with the system 500. At step 508, the money may be transferred to a merchant account associated with system 500. The money may remain in the system pending a request for a donation is received at system 500 that may correlate to an event that the donor may have assigned the donation to.

At step 510, the processor may be configured to create a plurality of sub-assets based on the data included in the data packet. In this example, there are 10 sub-assets created based off of the donation of $1000.00. Each of sub-assets 1-10 may include metadata associated with the sub-asset. Each of sub-assets 1-10 may be equal to a value of 100. Sub-asset number one, as shown at 512, may include the donor name, Joe. The value may be equal to 100. The events may be equal to natural disaster (“ND”) and Poverty (“POV”.) Sub-asset number 2, as shown at 514, may include the donor name, Joe. The value may also be equal to 100. The events may also be equal to ND and POV. Sub-assets numbers 3-9 may also be created but may not be shown in diagram 500. Sub-asset number 10, as shown at 516, may include the donor name, Joe. The value may also be equal to 100. The event may be equal to ND and POV. Each of the sub-assets may also record a routing number associated with the system 500 for use when transferring the donation to a charitable organization.

At column 3, shown at 518, the distributed network 520 may record the sub-assets and the metadata associated with each sub-asset in a block 522 on a blockchain. The distributed network 520 may be in electronic communication with the processor. The processor may be a centralized and/or a decentralized processor. Block 522 may record sub-assets numbers 1-10 and the associated metadata. In this example, the donation is divided and recorded in 10 sub-assets where each sub-asset is equal to a value of 100 based off the donation of $1000.00. In a different example, the system may be configured to create 1000 sub-assets where each sub-asset is equal to a value of 1 based off the donation of $1000.00.

Sub-asset number one may be recorded in block 522 at 524. Sub-asset number two may also be recorded in block 522 at 526. Sub-asset number three may be recorded in block 522 at 528. Sub-asset number 4 may be recorded in block 522 at 530. Sub-assets 5-9 may also be recorded in block 522 but may not be shown in diagram 500. Sub-asset number 10 may be recorded in block 522 at 532.

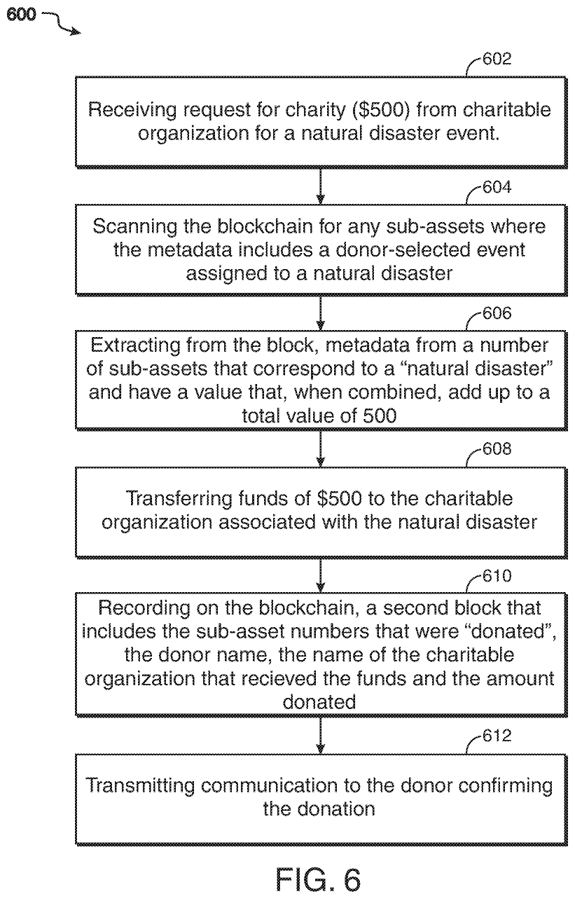

FIG. 6 shows an exemplary flow chart 600 of a method for processing a request for a donation. This exemplary flow chart 600 may be associated with exemplary diagram 500, as shown in FIG. 5. At step 602, the method may include receiving a request for a charity (“RFC”) donation of $500, from a charitable organization associated with a natural disaster event. At step 604, the method may include scanning the blockchain for any sub-assets where the metadata includes a donor-selected event allocated to a natural disaster. At step 606, the method may include, extracting from block 522 metadata from a number of sub-assets that the event corresponds to ‘natural disaster’ and has a value that when combined, add up to a total of 500. At step 608, the method may include transferring the funds of $500.00 to the charitable organization associated with the natural disaster.

At step 610, the method may further include recording on the blockchain, a second block. The second block may include the sub-asset numbers that were ‘donated’, and the donor name, the name of the charitable organization that received the funds and the amount donated. Following the recording, the method may include transmitting communication to the donor of confirmation of the donation, as shown at step 612.

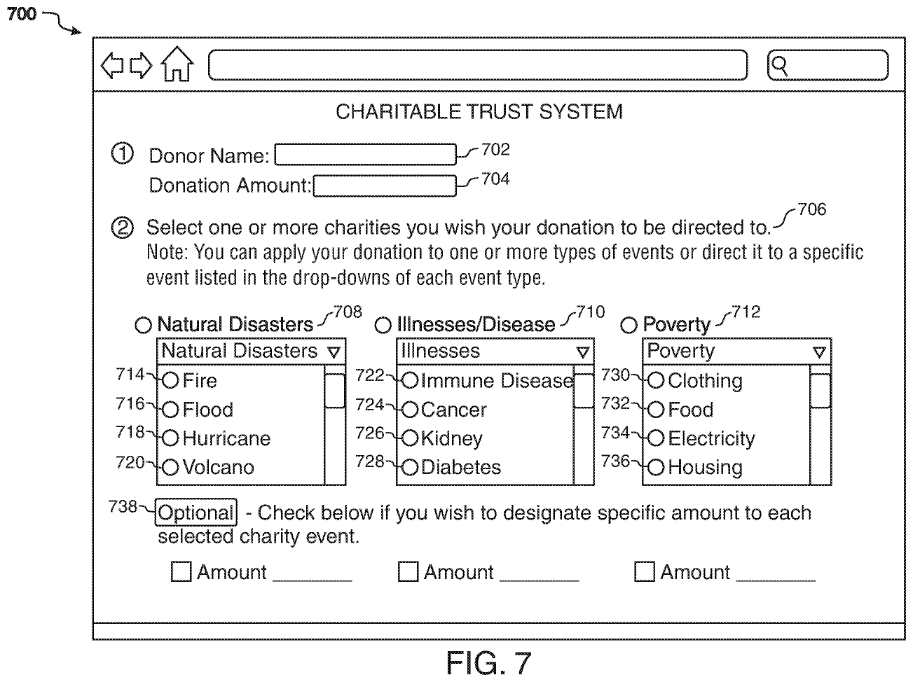

FIG. 7 shows a graphical user interface (“GUI”) 700 for a charitable trust system. The charitable trust system may be an online web site that accepts donations for a large plurality of organizations. GUI 700 may enable a donor to submit a donation and select the exact organization and/or type of organization the donor would like the donation to be directed.

At step number one, a donor name may be entered at text-box 702. The donation amount may be entered at text-box 704. At step number two 706, the donor is enabled to select one or more charities that the donation may be directed to. GUI 700 may display three different types of events. The charitable trust system may include many more types of events not shown in this exemplary GUI. The charitable trust system may also include a list of specific charity organizations that can be selected as opposed to a type of charity and/or a type of event.

GUI 700 displays an option for a selection of an event-type associated with natural disasters, as shown at 708. The natural disasters option 708 may also include a drop-down menu of specific types of natural disasters. The donor may select only the natural disaster option. The donor may select a specific natural disaster. The specific natural disasters listed, but are not limited to, are a fire 714, a flood 716, a hurricane 718 and a volcano 720. GUI 700 further displays an option for a selection of an event-type associated with illnesses and diseases, as shown at 710. The illnesses/disease option 710 may also include a drop-down menu of specific types of illnesses and diseases. The donor may select only the illness/disease option. The donor may select a specific illness/disease. The specific illnesses/diseases listed, but are not limited to, are an immune disorder 722, cancer 724, kidney 726 and diabetes 728.

GUI 700 further displays an option for a selection of an event-type associated with poverty, as shown at 712. The poverty option 712 may also include a drop-down menu of specific types needs associated with poverty. The donor may select only the poverty option. The donor may select a specific type of need associated with poverty. The specific poverty types of needs listed, but are not limited to, are clothing 730, food 732, electricity 734 and housing 736.

The donor may be enabled to divide the donation amount. The donor may be able to designate specific portions of the donation to specific events. Option 738 may display the option. A specific amount may be entered for each event that may be selected by the donor. The data entered in GUI 700 may be saved in the system. The data may be processed by a processor of the system and may be recorded within a blockchain. The data inputted by the donor may be the metadata included in each sub-asset created for the received donation.

The GUI may further include, but may not be illustrated on GUI 700, a list of numerous specific charity organizations that a donor may direct his funds. The donor may select one or more specific charity organizations that may be potential recipients of the donation and/or may instantly receive the donor's funds at the time of the donation.

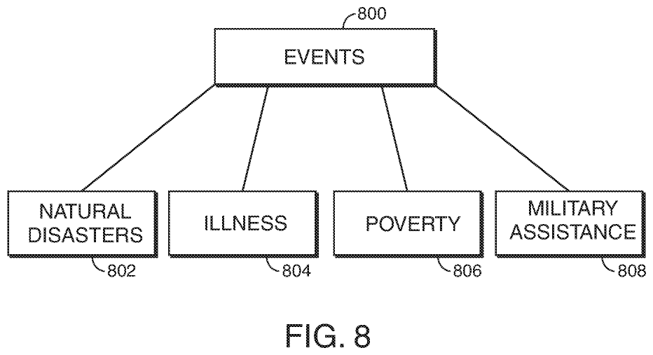

FIGS. 8-11 may be directed to illustrative exemplary diagrams of different levels of events in accordance with principles of the invention. The different levels illustrated may include a high-level of events, specific types of events and explicit events that may be included within the charitable trust system. These events are associated with charitable organizations that may be recipients for donations. The system may enable a donor to aggregate any amount of the donation to one or more events. The donor may be enabled, within the charitable trust system, to select and direct the donation to a specific recipient within the organization. These exemplary diagrams show the different levels at which a donor can select to be the recipient of a whole or a portion of the donor's contribution. The events and categories listed in FIGS. 8-11 may be examples and the charitable trust system may be configured to include many other event types, categories and charitable organizations not included in the diagrams. Other examples may include education, research, preservation of natural habitat and cyber security. The events may be included within the charitable trust system. These events may be included because charitable organizations may have registered their organizations and related events within the system. Each event within the organization may be included as a profile within the system and may be viewed and accessed by potential donors. The events may be added in real-time, based on social media, news channels and other methods via the internet.

FIG. 8 shows an illustrative diagram 800. Diagram 800 may illustrate examples of events that may be included within a charitable trust system. The charitable trust system is not limited to the events listed here. The events may include natural disasters 802, illness 804, poverty 806 and/or military assistance 808.

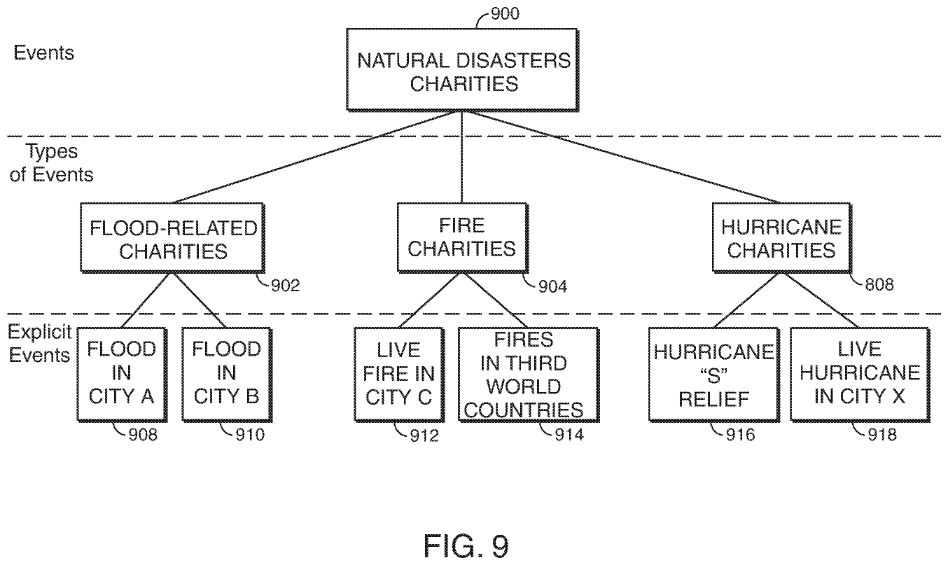

FIG. 9 shows an illustrative diagram of specific events that may be included within a high level of events. There may be different levels of specificity. An event can be selected from a high level event. An event can be selected at a more specific level, being a type of event. An event can further be specified at an even more specific level, where the exact recipient within the event is specified. The high level event listed is natural disaster charities, as shown at 900. The specific events within natural disasters illustrated are flood-related charities 902, fire charities 904 and hurricane charities 906. The flood-related charities 902 may be further specified to specific events that may be occurring in real-time. Flood-related charities 902 may include a specific flood occurring in city A, as shown at 908. It may further include a flood in city B, as shown at 910. Fire-type charities 904 may include a live fire in city C, as shown at 912. It may further include fire in third world countries, as shown at 914. Hurricane-type charities 906 may include relief for hurricane S, as shown at 916. It may further include a live hurricane associated with city X, as shown at 918.

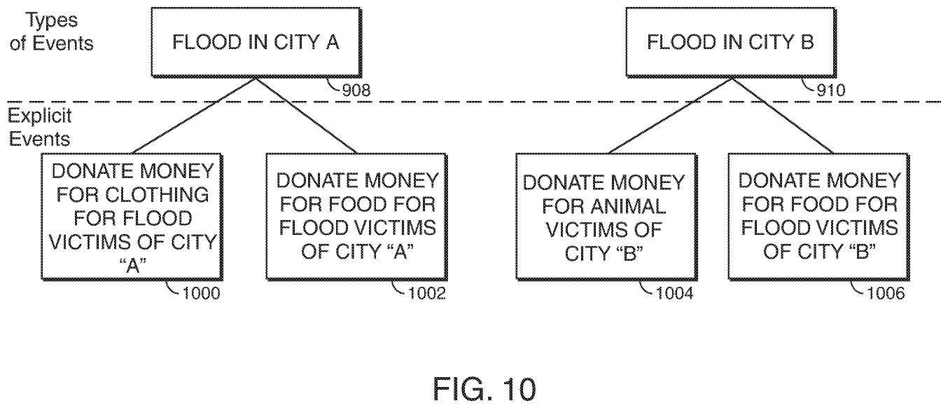

FIG. 10 shows an illustrative exemplary diagram of specific events that may be selected by a donor. This charitable trust system enables a donor to specify a direct and exact location to which the donation should be directed. In this exemplary diagram, the donor may select as the event, a flood in city A, as shown at 908. Within the flood at city A, the donor may be enabled to donate his money to purchase new clothing for flood victims of city A, as shown at 1000. The donor may specify that the donation should be directed to purchase food for flood victims of city A, as shown at 1002. When there are multiple floods occurring at the same time, the donor may select to direct his donation to a flood in city B, as shown at 910. The donor may further specify that the donation should be to assist animal victims within city B, as shown at 1004. The donor may specify that the donation should be directed to purchase food for flood victims of city B, as shown at 1006.

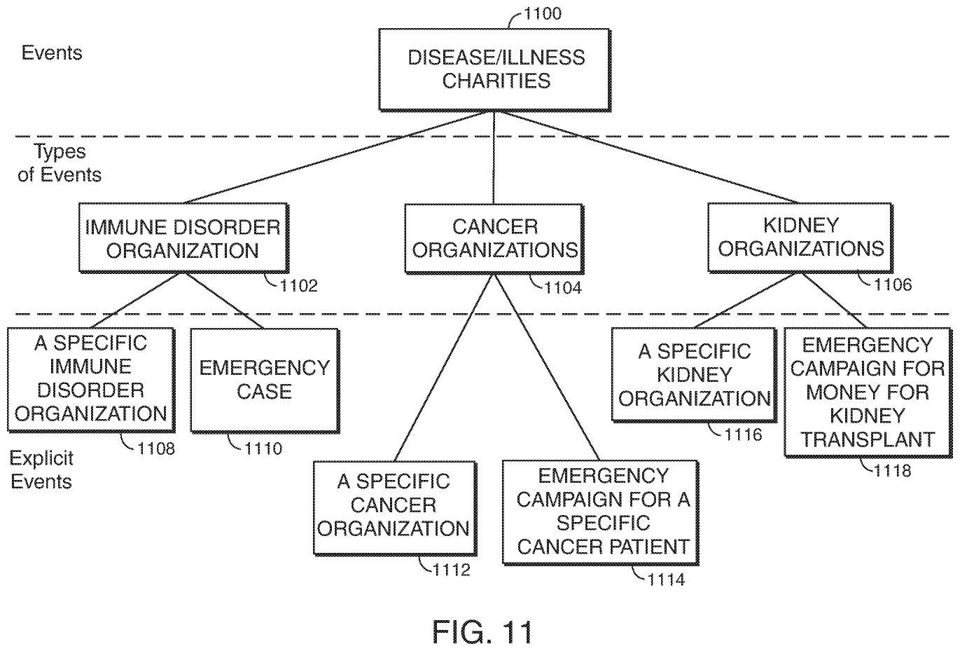

FIG. 11 shows another illustrative exemplary diagram of specific events that may be included within another wide-ranging event. In this exemplary diagram, different types of events that may fall under the category of diseases and illnesses 1100 may be shown. The types of events listed, but not limited to are, immune disorder organizations 1102, cancer organizations 1104 and kidney organizations 1106.

At an even more specific level, a donor may have the option to direct his donation to a specific recipient within the type of illness selected. A donor may select a specific immune disorder organization as shown at 1108. A donor may select an emergency case of an immune disorder that may be broadcasted in the news and/or on social media, as shown at 1110.

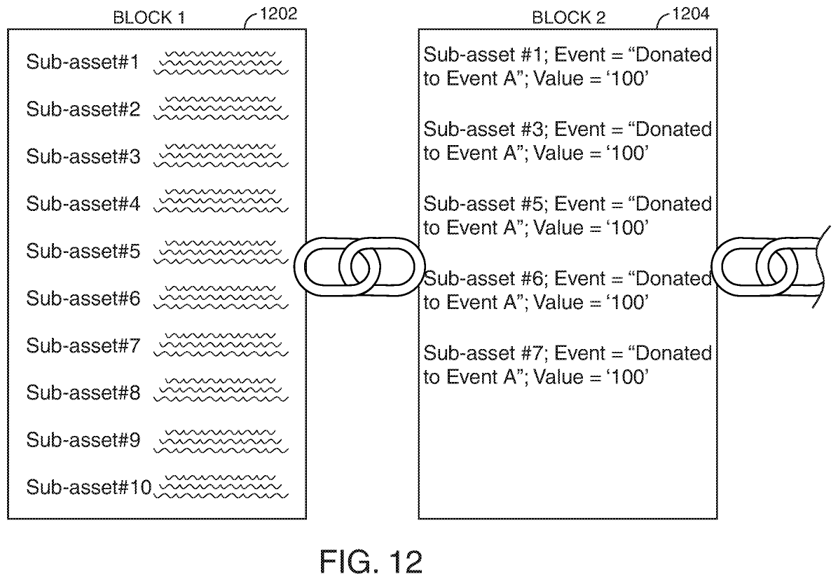

FIG. 12 shows an illustrative exemplary diagram of two blocks on a blockchain. The blockchain may include a plurality of blocks that may not be illustrated. Block 1, as shown at 1202, may record the data associated with a donation received from a donor at the time of the receipt of the donation. The donation, in this example, may be divided into 10 sub-assets. For each sub-asset, metadata may be recorded including the donor-selected events that the donor may request the donation to be directed to. Block 2, as shown at 1204, may record the outcome of at least a part of the donation according to the donor's preferences. Block 2 may record metadata associated with each sub-asset where the portion of the value of funds of the sub-asset have been transferred to a charity organization. The metadata recorded may include the sub-asset number, the event that actually received the donation and the numerical value equal to the amount donated. Blocks 1202 and 1204, and any other blocks on the blockchain, may be viewed and audited as an open ledger to users of the system.

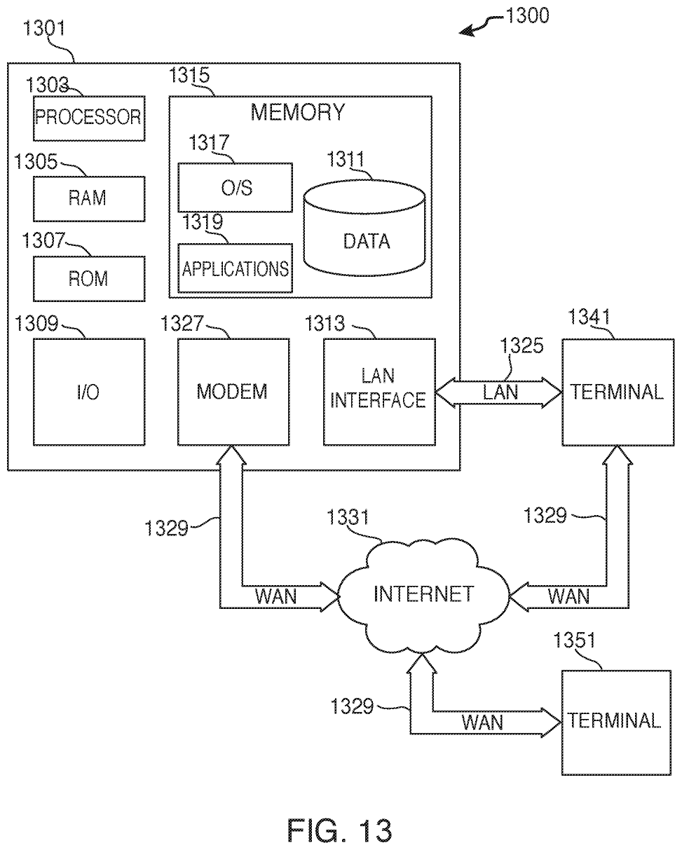

FIG. 13 shows an illustrative block diagram of system 1300 that includes computer 1301. Computer 1301 may alternatively be referred to herein as a “server” or a “computing device.” Computer 1301 may be a desktop, laptop, tablet, smart phone, or any other suitable computing device.

Computer 1301 may have a processor 1303 for controlling the operation of the device and its associated components, and may include RAM 1305, ROM 1307, input/output module 1309, and a memory 1315. The processor 1303 may also execute all software running on the computer—e.g. the operating system and/or voice recognition software. Other components commonly used for computers, such as EEPROM or Flash memory or any other suitable components, may also be part of the computer 1301.

The memory 1315 may be comprised of any suitable permanent storage technology—e.g., a hard drive. The memory 1315 stores software including the operating system 1317 any application(s) 1319 along with any data 1311 needed for the operation of the system 1300. Memory 1315 may also store videos, text, and/or audio assistance files. The videos, text, and/or audio assistance files may also be stored in cache memory, or any other suitable memory. Alternatively, some or all of computer executable instructions may be embodied in hardware or firmware (not shown). The computer 1301 may execute the instructions embodied by the software to perform various functions.

Input/output (“I/O”) module may include connectivity to a microphone, keyboard, touch screen, mouse, and/or stylus through which a user of computer 1301 may provide input. The input may include input relating to cursor movement. The input may be included in a transfer event or an escape event. The input/output module may also include one or more speakers for providing audio output and a video display device for providing textual, audio, audiovisual, and/or graphical output. The input and output may be related to computer application functionality.

System 1300 may be connected to other systems via a local area network (LAN) interface 1313.

System 1300 may operate in a networked environment supporting connections to one or more remote computers, such as terminals 1341 and 1351. Terminals 1341 and 1351 may be personal computers or servers that include many or all of the elements described above relative to system 1300. Terminals 1341 and 1351 may be donor computers connecting the charitable trust system. The network connections depicted in FIG. 13 include a local area network (LAN) 1325 and a wide area network (WAN) 1329, but may also include other networks. When used in a LAN networking environment, computer 1301 is connected to LAN 1325 through a LAN interface or adapter 1313. When used in a WAN networking environment, computer 1301 may include a modem 1327 or other means for establishing communications over WAN 1329, such as Internet 1331. The network connections.

It will be appreciated that the network connections shown are illustrative and other means of establishing a communications link between computers may be used. The existence of various well-known protocols such as TCP/IP, Ethernet, FTP, HTTP and the like is presumed, and the system can be operated in a client-server configuration to permit a user to retrieve web pages from a web-based server.

The web-based server may transmit data to any other suitable computer system. The web-based server may also send computer-readable instructions, together with the data, to any suitable computer system. The computer-readable instructions may be to store the data in cache memory, the hard drive, secondary memory, or any other suitable memory. The transmission of the data together with computer-readable instructions may enable the computer system to quickly retrieve the data, when needed. Because the computer system is able to quickly retrieve the data, the web-based server need not stream the data to the computer system. This may be beneficial for the computer system, because the retrieval may be faster than data-streaming. Users may not become frustrated because they do not need to wait to run the applications. Conventionally, streaming data requires heavy usage of the processor and the cache memory. If the data is stored in the computer system's memory, retrieval of the data may not require heavy processor and cache memory usage. Any of various conventional web browsers can be used to display and manipulate retrieved data on web pages.

Additionally, application program(s) 1319, which may be used by computer 1301, may include computer executable instructions for invoking user functionality related to communication, such as e-mail, Short Message Service (SMS), and voice input and speech recognition applications. Application program(s) 1319 (which may be alternatively referred to herein as “applications”) may include computer executable instructions for invoking user functionality related performing various tasks. The various tasks may be related to the user's finances, shopping, recreation, relationships, or other business or personal affairs. Applications 1319 may generate signals. Applications 1319 may include a central application and a plurality of peripheral applications.

Computer 1301 and/or terminals 1341 and 1351 may also be devices including various other components, such as a battery, speaker, antennas (not shown).

Terminal 1351 and/or terminal 1341 may be portable devices such as a laptop, cell phone, Blackberry™, tablet, smartphone, or any other suitable device for receiving, storing, transmitting and/or displaying relevant information. Terminals 1351 and/or terminal 1341 may be other devices. These devices may be identical to system 1300 or different. The differences may be related to hardware components and/or software components.

Any information described above in connection with database 1311, and any other suitable information, may be stored in memory 1315. One or more of applications 1319 may include one or more algorithms that may be used to implement services provided by the central application, secondary applications, and/or any other suitable tasks.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, mobile phones and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

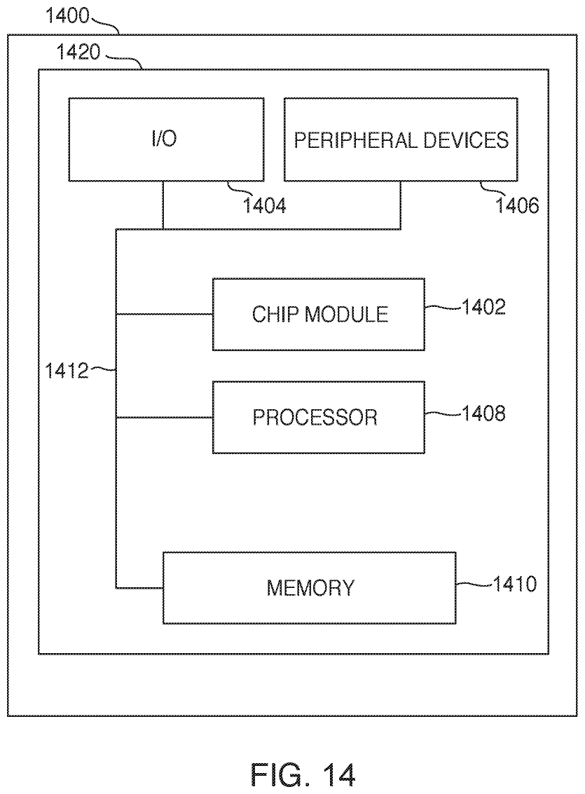

FIG. 14 shows illustrative apparatus 1400 that may be configured in accordance with the principles of the disclosure. Apparatus 1400 may be a computing machine. Apparatus 1400 may include one or more features of the apparatus shown in FIG. 14. Apparatus 1400 may include chip module 1402, which may include one or more integrated circuits, and which may include logic configured to perform any other suitable logical operations.

Apparatus 1400 may include one or more of the following components: I/O circuitry 1404, which may include a transmitter device and a receiver device and may interface with fiber optic cable, coaxial cable, telephone lines, wireless devices, PHY layer hardware, a keypad/display control device or any other suitable media or devices; peripheral devices 1406, which may include counter timers, real-time timers, power-on reset generators or any other suitable peripheral devices; logical processing device 1408, which may compute data structural information and structural parameters of the data; and machine-readable memory 1410.

Machine-readable memory 1410 may be configured to store in machine-readable data structures: machine executable instructions (which may be alternatively referred to herein as “computer code”), applications, signals, and/or any other suitable information or data structures.

Components 1402, 1404, 1406, 1408 and 1410 may be coupled together by a system bus or other interconnections 1412 and may be present on one or more circuit boards such as 1420. In some embodiments, the components may be integrated into a single chip. The chip may be silicon-based.

Thus, methods and apparatus for facilitating donor-controlled distribution of charitable donations within a charitable trust system have been provided. Persons skilled in the art will appreciate that the present invention can be practiced by other than the described embodiments, which are presented for purposes of illustration rather than of limitation. The present invention is limited only by the claims that follow.

What is claimed is:

1. A method for facilitating donor-controlled distribution of charitable donations, the method comprising:
receiving data from a donor corresponding to a donation of a value of funds to a charitable trust system;
creating a plurality of sub-assets, each sub-asset relating to a portion of the value of funds;
assigning, to each of the plurality of sub-assets, a sub-asset number;
receiving an identification of a plurality of donor-selected events selected by the donor, each of the plurality of donor-selected events associated with a charitable organization;
associating each of the sub-assets with each of the plurality of donor-selected events;
adding to a blockchain a first block, the first block recording metadata for each of the sub-assets, the metadata comprising:
a name of the donor;
the sub-asset number;
the donor-selected events associated with each sub-asset; and
a numeric value of the related portion of funds;
receiving a request for charity (“RFC”) from a charitable organization, the RFC including a requested donation amount, the RFC being associated with an RFC event;
scanning the blockchain, for one or more sub-assets associated with a donor-selected event correlating to the RFC event;
extracting from the blockchain the metadata from a number of sub-assets correlating to the RFC event, wherein a total of the portion of the value of funds associated with each of the number of sub-assets add up to the requested donation amount, the number of sub-assets including one or more of the plurality of sub-assets associated with the donor;
completing a transaction of the requested donation amount to the charitable organization, the completing comprising transferring a value of funds from the charitable trust system to the charitable organization, the value of funds being a total value of the numeric value for each of the extracted sub-assets;
creating a second block, the second block recording the completed transaction listing each of the sub-assets correlating to the RFC event, the total value of the sub-assets and the charitable organization associated with the RFC where the value of funds has been transferred; and
transmitting a communication to the donor comprising:
confirmation of the transaction;
the charitable organization associated with the RFC event that received the requested donation amount; and
the value of funds transferred to the charitable organization.

2. The method of claim 1 wherein the data comprises:
a donor-name;
a donation amount equal to the value of funds donated; and
payment information.

3. The method of claim 1 wherein the creating of the plurality of sub-assets further comprises creating a number of sub-assets equal to the value of funds donated.

4. The method of claim 3 wherein the receiving from the donor a plurality of events further comprises receiving the plurality of events and a pre-determined amount to be allocated to each of the plurality of events.

5. The method of claim 4, wherein the recording on the first block each of the sub-assets further comprises recording further routing data associated with the charitable trust system.

6. The method of claim 1 wherein the scanning the blockchain further comprises scanning from an oldest-date stamped block to a latest-date stamped block, thereby creating a hierarchy enabling an earlier donor to donate prior to a subsequent donor.

7. The method of claim 1 wherein, in response to the scanning the blockchain, the method further comprises determining that no donor-selected events correlate to the RFC event.

8. The method of claim 7, wherein in response to the determination that no donor-selected events correlate to the RFC event, the method further comprises:
retrieving an event associated with one or more sub-assets that correlates with an event outside the RFC event; and
transmitting a notification to the donor associated with the one or more sub-assets for a request of an exception for redirection of the sub-asset to the RFC event.

9. The method of claim 8 further comprising:
receiving a confirmation from the donor to, redirect the donor-selected events of the one or more sub-assets, to the requested charitable organization;
extracting from the blockchain, metadata from the one or more sub-assets associated with the donor that confirmed request for exception;
completing a transaction of the requested donation amount, based on the metadata, to the charitable organization;
recording on the second block, a list of each of the sub-assets extracted from the blockchain, metadata associated with each of the extracted sub-assets and confirmation data confirming the redirection of the sub-assets to the requested charitable organization.

10. The method of claim 1 wherein the scanning further comprises determining a word match between data included in the RFC event and data associated with the donor-selected events.

11. A charitable trust system, the system facilitating donor-controlled distribution of charitable donations, the system comprising:
a processor configured to:
receive data from a donor corresponding to a donation of a value of funds to the charitable trust system;
create a plurality of sub-assets, each sub-asset relating to a portion of the value of funds;
assign, to each of the plurality of sub-assets, a sub-asset number;
receive identification of a plurality of donor-selected types of events selected by the donor, the plurality of donor-selected types of events being associated with a charitable organization; and
associate each of the sub-assets with each of the plurality of donor-selected types of events;
the processor in electronic communication with at least one of a plurality of decentralized nodes within a distributed network, the distributed network configured to add to a blockchain a first block, the first block recording metadata for each of the sub-assets, the metadata comprising:
a name of the donor;
the sub-asset number;
the donor-selected types of events associated with each sub-asset; and
a numeric value of the related portion of funds;
wherein:
when a request is received for a request for charity (“RFC”) from a charitable organization, the RFC being associated with an RFC event, the RFC including a requested donation amount:
the processor is further configured to:
scan the blockchain for one or more sub-assets associated with a donor-selected type of event correlating to the RFC event;
extract from the blockchain metadata of a number of sub-assets associated with the RFC event, wherein a total of the portion of the value of funds associated with each of the number of sub-assets add up to the requested donation amount; and
complete a transaction of the requested donation amount to the charitable organization, the completing comprising a transfer of funds of the requested donation amount from the charitable trust system to the charitable organization, the value of funds being a total value of the numeric value for each of the extracted sub-assets;
the distributed network is further configured to:
create a second block, the second block for recording the completed transaction listing each of the extracted sub-assets, the total value of the extracted sub-assets and the charitable organization associated with the RFC where the value of funds has been transferred; and
transmit a communication to the donor comprising:
a confirmation of the transaction;
the value of funds transferred to the charitable organization; and
the charitable organization associated with the RFC where the value of funds has been transferred.

12. The system of claim 11 wherein the data comprises:
a donor-name;
a donation amount equal to the value of funds donated; and
payment information.

13. The system of claim 11 wherein the receiving from the donor a plurality of donor-selected types of events further comprises receiving a pre-determined amount to be allocated to each of the plurality of donor-selected types of events.

14. The system of claim 11 wherein, in response to the scanning the blockchain, the processor is further configured to determine that no donor-selected types of events correlate to the RFC event.

15. The system of claim 15 wherein, in response to the determination that no donor-selected types of events correlate to the RFC event, the processor is further configured to:
retrieve a donor-selected type of event that correlates with an event outside the RFC event; and
transmit a notification to the donor associated with the one or more sub-assets for a request of an exception for redirection of the sub-asset to the requested charitable organization.

16. The system of claim 14 wherein, in response to the transmittal of a notification for the request, the processor is further configured to:
receive a confirmation from the donor to redirect, the donor-selected types of events of the one or more sub-assets, to the requested charitable organization;
extract from the blockchain, metadata from the one or more sub-assets that received the confirmation for the exception request;
complete a transaction of the requested donation amount to the charitable organization;
record on the second block, a list of each of the sub-assets extracted from the blockchain, metadata associated with each of the extracted sub-assets and confirmation data confirming the redirection of the sub-assets to the requested charitable organization.

17. The system of claim 11 wherein the processor is further configured to transmit to the donor an image or video of an actualization of actions taken pursuant to the donation.

18. A charitable trust system, the system facilitating donor-controlled distribution of charitable donations, the system comprising:
a processor configured to:
receive a plurality of data, each of the plurality of data relating to a donation of a value of funds to the charitable trust system, each of the plurality of data being associated with a distinct donor;
create an asset for each of the plurality of data, each asset corresponding to the value of funds, wherein each asset comprises a plurality of sub-assets, each of the plurality of sub-assets corresponding to a portion of the value of funds associated with the asset; and
assign to each asset an asset number;
assign to each of the plurality of sub-assets, a sub-asset number;
receive for each asset, from each donor, an identification of a plurality of donor-selected events, the plurality of donor-selected events being associated with a charity organization; and
associate, for each asset, and each of the plurality of sub-assets comprised within the asset, the plurality of donor-selected events;
the processor in electronic communication with at least one of a plurality of decentralized nodes within a distributed network, the distributed network configured to add to a blockchain a plurality of blocks, the plurality of blocks recording metadata for the plurality of assets, wherein each block is configured to record:
asset metadata for each asset; and
sub-asset metadata for each of the plurality of sub-assets;
wherein:
when a request is received for a request for charity (“RFC”) from a charitable organization, the RFC being associated with an RFC event, the RFC including a requested donation amount:
the processor is further configured to:
scan the blockchain for one or more sub-assets associated with a donor-selected event correlating to the RFC event;
extract from the blockchain sub-asset metadata from a number of sub-assets associated with the RFC event, wherein a total of the portion of the value of funds associated with each of the number of sub-assets add up to the requested donation amount; and
complete a transaction of the requested donation amount to the charitable organization, the completing comprising a transfer of funds of the requested donation amount from the charitable trust system to the charitable organization, the value of funds being a total value of the portion of the value of funds associated with each of the extracted sub-assets;
the distributed network is further configured to:
create an additional block, the additional block for recording the completed transaction listing each of the extracted sub-assets, the total value associated with the extracted sub-assets and the charitable organization associated with the RFC where the value of funds has been transferred; and
transmit a communication to the donor comprising:
a confirmation of the transaction;
the value of funds transferred to the charitable organization; and
the charitable organization associated with the RFC where the value of funds has been transferred.

19. The system of claim 18 wherein the asset metadata comprises:
a name of the donor;
the asset number;
the plurality of sub-asset numbers associated with the asset number;
a numeric value of the value of donated funds; and
the donor-selected events.

20. The system of claim 18 wherein the sub-asset metadata comprises:
the sub-asset number;
the donor-selected events; and
a numeric value of the related portion of funds.
